(19) United States
(12) Patent Application Publication
(10) Pub. No.: US 2026/0054111 A1
(43) Pub. Date: Feb. 26, 2026

(54) External Fire Protection and Suppression System

(71) Applicant: Richard William Hoffmann, Willamina, OR (US)

(72) Inventor: Richard William Hoffmann, Willamina, OR (US)

(21) Appl. No.: 19/308,054

(22) Filed: Aug. 22, 2025

Related U.S. Application Data
(60) Provisional application No. 63/660,965, filed on Aug. 23, 2024.

(51) Int. Cl. A62C 3/02; A62C 37/36; A62C 37/38

(52) U.S. Cl. CPC A62C 3/0214; A62C 37/04; A62C 37/38

(57) ABSTRACT

Described herein is an external fire protection system utilizing both fire hoses and fixed atomized water sprinklers. Water is supplied by either a local utility or static source pressurized by reciprocating or auxiliary electric engine employing high pressure/high volume pumps that are independent of any power grid outages. Both manual and local heat sensor detection are incorporated for automatic activation. The system also includes remote activation via any WiFi internet source (e.g., satellite) via a phone app to any programmable logic controller for continuous or water-saving intermittent operation.

### CLAIM TO PRIORITY TO A PROVISIONAL APPLICATION

This non-provisional patent application claims priority to U.S. Provisional Application No. 63/660,965, “External Fire Suppression Sprinkler System” filed on Aug. 23, 2024.

### BACKGROUND

Wildland fires are an increasing threat. Homes and other structures that border or are in wildland areas such as forests are vulnerable to total destruction from wildfire during summer season and also during other parts of the year from increasingly dry and warm climate conditions. An automated and reliable fire protection system is needed to provide protection to homes and other structures in such areas.

### BRIEF DESCRIPTION OF THE DRAWINGS

FIG. 1 is a depiction a deployment of the disclosed external fire protection system mounted on structure, in accordance with at least one embodiment.

FIG. 2A shows a first water spray pattern of multidirectional sprinklers in relation to a sideview of a structure, in accordance with at least one embodiment.

FIG. 2B shows a second water spray pattern of multidirectional sprinklers in relation to a sideview of a structure, in accordance with at least one embodiment.

FIG. 3A shows a detailed view of a three-way cross configuration of a multidirectional sprinkler, in accordance with at least one embodiment.

FIG. 3B shows a detailed view of a four-way cross configuration of a multidirectional sprinkler, in accordance with at least one embodiment.

FIG. 4 shows an example of a vertical wetting pattern from a four-way multidirectional sprinkler, in accordance with at least one embodiment.

FIG. 5 shows an example of a lateral wetting patter from a four-way multidirectional sprinkler, in accordance with at least one embodiment.

FIG. 6 shows a diagram of a control system for manual and automatic control of the disclosed fire protection system in accordance with at least one embodiment.

FIG. 7 shows a diagram of central hub subsystem of the disclosed fire protection system, in accordance with at least one embodiment.

FIG. 8 shows a diagram of pump control subsystem of the disclosed fire protection system, in accordance with at least one embodiment.

### SUMMARY

A complete system that is designed and engineered to increase the probability that a home or business, especially in the wildland fire-urban Interface, can survive a fast-moving wildland fire or other extreme heat energy threat. It comprises a system that utilizes the synergy of multiple products and methodologies, including the direct and indirect (wind-driven) application of water and fire service-approved firefighting foam or other wetting agents on exterior surfaces to create a highly effective ignition resistance surface to convected, radiant and conducted heat energy associated thereof.

The novelty of the methodology is the incorporation of an annual application of a biodegradable organic certified heat energy inhibitor or similar product, such as GreenFire Pro-Defense® sprayed on all surfaces after the last seasonal Spring rains have subsided; the painting of all exterior surfaces with a heat energy inhibitor or similar product paint additive or clear compound similar to FlameCheck® to create a Class A fire rating on all affected surfaces. The installation of an exterior fire sprinkler system is to dampen or wet any ignitable surface prior to and after exposure. The installation of fire attack hose lines and pumps adequate to maintain proper fire stream water flow rates identical to that of any current fire apparatus in service today; and lastly the manual (on-site electrical switch). Remote operation may be enabled by a phone app. On-site heat and smoke sensors may be employed for semi-auto and automatic activation long before and immediately upon the arrival of any (i.e., wildland, etc.) extreme heat energy threat, and especially when occupants are not present.

The pumps may be high pressure/high volume pump(s) in that the minimum requirement (depending on facility/home size and application) produces a minimum of 112 PSI at 92 gallons per minute flow rate. An example is an electrical pump system comprising two pumps plumbed one into the next in series, whereby each pump is capable of delivering 56 PSI at 92 gallons per minute flow rate. Pumps can be standard combustion gasoline or diesel fuel type, either manual or electric (remote and on-site) start, in which all WiFi and Bluetooth or other wireless communication sources are outage resistant to ensure remote activation/operation is powered by generator or other dependable electrical power grid independent source.

An exemplary external fire protection system includes a deployment of a fire-protection sprinkler system on a house. The novelty of electrical activation and operation circuitry is a timer device that only allows water and foam application for a minimal duration to ensure any surface becomes and remains too damp to meet its minimum ignition temperatures. The purpose is to provide 24/7 fire protection and prevent any on-site water well, municipal, or industrial emergency water supply system from being compromised or exhausted prematurely altogether and the risk of leaving any exposure vulnerable to zero fire protection, primarily when an on-site fire threat occurs.

The electrical circuitry ensures all zones quickly activate and alternate between zones to maintain minimum water pressure flow ratings for proper application before shutting down to allow the refilling of an on-site water supply system back to or near total capacity to extend the fire protection timeline nearly indefinitely. Reactivation/operation will only be necessary once the on-site relative humidity and fuel moisture content readings fall below the minimum parameters and the fuel surface is again at risk of ignition. Upon meeting these minimums, the system pauses, saving critical water resources from waste without compromising water storage capacities.

When no sensor activation/pause/reactivation equipment is installed, the system is activated for one (1) minute ON per zone followed by a zero operation timeline equal to the one-to-one recovery ratio of up to 45 minutes to an hour between applications. The GPM flow water well aquifer recovery rate determines the time between fire protection application and downtime to ensure that the supporting on-site (i.e., cistern tank) water storage remains full.

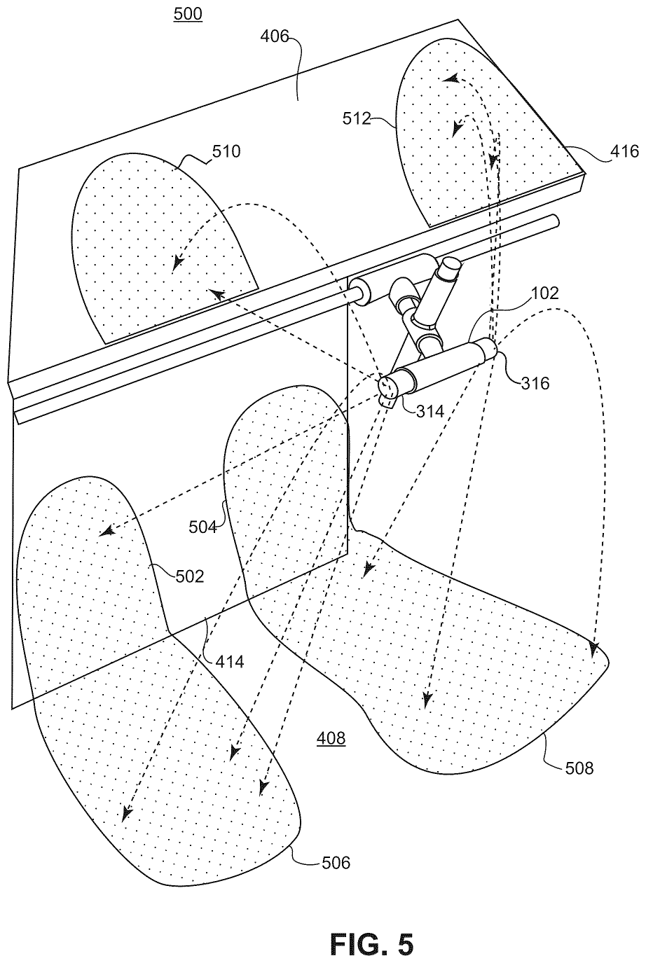

The manually operated electrical switches shown in FIG. 5 are wired in a manner to both operate the exterior fire sprinklers intermittently or in emergency modes upon opening and closing the low voltage electrical ball valves in a manner that on-site personnel can operate the fire attack hose lines without loss of water pressure from the simultaneous operation of the sprinklers. Fire sprinkler emergency mode initiates multiple repeated zone activation cycles (the preferred method is ten (10) cycles, consuming as much as ⅔rds the tank capacities). At this point (or when an optional water tank level sensor determines one-third (⅓) tank capacity, manual reactivation is required to ensure the water tank capacity is never compromised at any time remaining water resources are depleted to prevent the utilization of the on-site fire attack hose lines.

The advantage of on-site high-pressure/high-volume fire pumps is that they can deploy two fire attack hose lines simultaneously. First, for personnel safety, the water and foam/wetting agents can be sprayed onto one another during extreme fire conditions as warranted. Secondly, water and foam/wetting agents are effectively applied more thoroughly to any surface before retreating indoors as a shelter in place safe refuge.

The sprinkler heads are not the same type or arrangement as NFPA Title 13 Fire Sprinkler System interior installation standards. Instead, these are low-flow design configurations created to produce highly atomized, extremely fine water droplets that can be wind-driven to land anywhere a burning ember may also land, thus rendering the surface nearly unignitable. Early activation ensures all surfaces are fully saturated before the arrival of a fire threat.

As an example, two DPDT electrical switches control the high-pressure/high-volume fire pumps. For example, a blue, waterproof, and security cover-protected switch is installed outside the waterproof box to activate/operate the fire pumps for the attack lines only; a red, waterproof, and security cover-protected switch is visibly adjacent to activate/operate the fire pumps for the external fire sprinklers in EMERGENCY mode. In all cases, the initial activation and continued or paused operation of the high-pressure/high-volume fire pumps is determined by a digital pressure switch that turns the pumps ON t at 30 PSI and turns the pumps OFF when they reach 85 PSI. In all scenarios, the 220V electrical circuit to the fire pumps will not activate until the manual or WiFi activated AC wall plug switches initiate a relay. This prevents the pumps from being accidentally activated until all other circuits are properly configured.

The electrical circuitry includes a waterproof electrical component box with a plethora of manual switches, relays, timer switches, and/or the combination of the programmable logic controller(s) and circuitry to activate and operate a plethora of electrical circuits for both manual and remote and automatic on-site sensor detection and activation of all electrical systems including electrical ball valves, electrical or combustion fuel fire pumps, and all related equipment accordingly.

As a further example, to ensure all systems are operating normally, a light tower of green under yellow and under red is located on the waterproof electrical component box at the fire attack hose, central hub location, and a green under red two color light tower is situated at the pump house and water tank location. A steady GREEN light in both areas confirms all systems are GO and standing by.

When the one-minute on and 45-minute intermittent fire sprinkler mode is initiated (e.g., via the Smart Life phone app), the yellow light blinks to verify this mode is activated at all times, yet immediately followed by the red LED light and an on-site audible alarm, the moment the pumps are energized for the duration of operation selected. When the fire pumps are initiated for operation, the red LED light will blink, and the audible alarm will sound.

How the sprinkler heads are installed on the perimeter loop pipe system utilizing, for example, NFPA Title 13 CPVC and other approved pipe is found in the illustrations attached, in that the water is either directly sprayed onto an ignitable surface or adjacent thereof to be wind-driven to land thereof accordingly, that a plurality of fittings and respective configurations are necessary to ensure maximum water and foam coverage accordingly. Hangers with opposing sprinkler head connectors are preferred in a parallel configuration, as the basic pipe members in which all fire department connections (FDC) and configurations are to NFPA 13 Standards.

The goal is to extend the immediate defensible space from the minimum of five (5′) feet from any structure or building to as much as 15′ to 20′ or more to be rendered as unignitable due to its wet or damp conditions upon minimal use of water as referred to herein.

### DETAILED DESCRIPTION

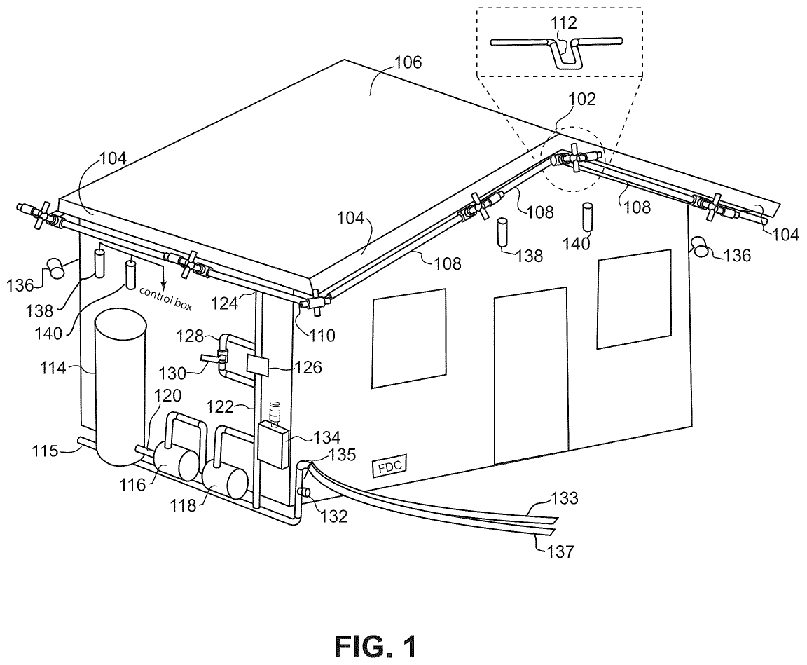

FIG. 1 shows a deployment of the disclosed external fire protection system (hereinafter “fire protection system”) 100 mounted on structure 102, which may be a residential home, commercial or other type of building. In at least one embodiment, fire protection system 100 includes a plurality of multidirectional sprinklers 102 mounted under the eaves 104 of roof 106 of structure 102. Multidirectional sprinklers 102 are interconnected by conduits 108. For example, a fire protection system 100 may comprise up to 34 sprinkler heads, each capable of spraying up to 3 gallons per minute (e.g., requiring a total flow of 102 gallons per minute, see below).

In at least one embodiment, multidirectional sprinklers comprise three for four individual sprinklers that are supported by coupler pipes or nipples interconnected by 3-way, 4-way or 5-way tees, for example, whereby individual sprinkler heads are attached on the ends of the coupler pipes. The coupler pipes may be oriented orthogonally with respect to one another, whereby coupler pipes are oriented substantially vertically and horizontally. In some embodiments, multidirectional sprinklers 102 comprise at least three sprinkler heads oriented in opposing orthogonal directions. In other embodiments, multidirectional sprinklers 102 may comprise sprinkler heads oriented in non-orthogonal directions. Sprinkler heads, described below, may have spray patterns that provide desired coverage by fine water sprays. The water sprays are atomized by the sprinkler heads to enable droplets of water to drift or be wind-blown in directions that incoming airborne embers may drift or be blown by wind. In this way, areas of coverage by water spray will be most effectively protected by water dampening in the event of a fire nearby and potentially approaching the structure. Multidirectional sprinklers are described in greater detail below.

Multidirectional sprinklers may be mounted at positions along straight sections of conduit 108, or attached to sections of conduit 108 adjoined at corners 110 of eaves 104, as shown. In at least one embodiment, joints on long lengths (e.g., 50 feet or more) of conduit 108 may be subject to expansion and contraction of the pipe, making the joints prone to breakage or cracking over time. To avoid such damage, conduits 108 may optionally incorporate U-shaped expansion segments (U-segments 112, see inset) to allow for flexibility in conduits 108 to expand and contract without cracking or breaking, where expansion and contraction of conduit 108 are due to wide environmental temperature fluctuations. For example, U segments 112 may have dimensions of 12 to 18 inches in width by approximately 30 inches vertically to allow for adequate flex, where U-segment 112 may be connected at the center of conduit 108, located at the apex of eave 104. In at least one embodiment, conduits 108 are 1 inch diameter pipe. For example, conduits are polyvinyl chloride pipes (PVC or CPVC). In at least one embodiment, conduits 108 are connected in a continuous loop, enabling constant pressure along the conduit routing, ensuring each sprinkler head is at substantially the same pressure to have the desired flow rate.

In at least one embodiment, fire protection system 100 comprises storage tank 114, which may be at least a 500 gallon (e.g., approximately 2000 liter) water storage tank that is either pressurized or unpressurized. Storage tank 114 may be connected to a municipal water supply or a well, for example, in a rural installation, and have any suitable capacity. For example, storage tank 114 may have a capacity of 1000 gallons or more. In rural examples, storage tank 114 may be a 2000 or 3000 gallon water tank connected to a well pump, whereby the well is the water source. If a swimming pool, pond, lake, creek, river, or other sufficiently large body of water is immediately available close to the structure, it may also be employed as a water source. The capacity of storage tank 114 provides water to the plurality of multidirectional sprinklers 102. As will be explained below, fire protection system 100 will perform by spraying water for specified durations to dampen the structure and the immediate surroundings, requiring sufficient water volume to ensure the desired water coverage. Storage tank 114 may be coupled to a water source (e.g., municipal, well, swimming pool, etc.) via conduit 115.

Storage tank 114 may be coupled to pumps 116 and 118 via conduit 120. In at least one embodiment, pumps 116 and 118 are high pressure high flow pumps. In at least one embodiment, pumps 116 and 118 are coupled in series to achieve sufficient pressure to enable a flow rate of water from the plurality of multidirectional sprinklers. In some embodiments, a single high pressure, high flow rate pump may be employed. For example, pumps 114 and 116 may be 2-horsepower pumps capable of generating a flow rate of 92 gallons per minute or greater at approximately 56 psi. When coupled in series, the pressure may be 112 psi at 92 gallons per minute. While such a high flow rate may drain storage tank 114 In a short time, it will be shown below that the duration of spray is divided into short time periods to conserve water, providing enough water for effective fire protection by fire protection system 100.

Tandem pumps 116 and 118, or an equivalent single pump capable of generating sufficient pressure and flow rate, may couple to multidirectional sprinklers 102 via riser 122, which is coupled to the conduit system at junction 124. In at least one embodiment, riser 122, conduit 120 and other related conduits comprise 1½ inch steel, copper or PVC pipe. Junction 124 may be a reducing tee to adapt the 1½ inch pipe to the 1 inch pipe of conduit 108. In at least one embodiment, an electronic valve 126 may be mounted along riser 122 to monitor pressure within the conduit system. Electronic valve 126 may control water flow by opening and closing, to start or stop water flow to multidirectional sprinklers 102. In at least one embodiment, a bypass 128 that is gated by valve 130, which may be, for example, a shut-off valve

While fire protection system 100 provides automated control of pumps and sprinklers, fire protection system 100 also provide for manual operation. In at least one embodiment, fire protection system 100 comprises a fire department connection (FDC) inlet 132, to allow a fire truck to connect a hose to fire protection system 100 for supplying water in lieu of the municipal or local water supply. Bypass 128 may be engaged by opening valve 130, enabling manual operation of fire protection system 100 by drawing pressurized water from a fire truck connected to FDC inlet 132. Here, electronic valve 126 is bypassed by opening valve 130. In combination with electronic control effectuated by operation of manual or remotely controlled switches on control box 134 (see below), pumps 116 and 118 can be shut off for manual operation.

In at least one embodiment, fire protection system 100 further includes a heat sensor 136, a humidity sensor 138 and a smoke sensor 140. In at least one embodiment, heat sensor 136 may be an infrared camera. Heat sensor 136 may also provide a machine vision functionality to capture heat map images and identify flames, for example. In one example, heat sensor 136 may be mounted at corners of a structure, and is configured to have a 120 degree field of vision to survey around corners. Humidity sensor 138 may measure humidity for determining when wetting may be sufficient and signal control box 134 to cut off water to conserve water supplies. Smoke sensor 140 may be present to detect proximity and severity of nearby fire.

In at least one embodiment, fire protection system 100 comprises hoses 133 and 137 are attached to discharge 135. Pressure generated by pumps 116 and 118, which can reach 112 psi, may enable hoses 133 and 137 to be operated as tandem fire attack hoses.

It may be understood that FIG. 1 depicts an example configuration of the above described components of fire protection system 100, and that any suitable configuration of fire protection system 100 may be employed. For example, storage tank 114 may be situated a distance away from the structure shown in FIG. 1.

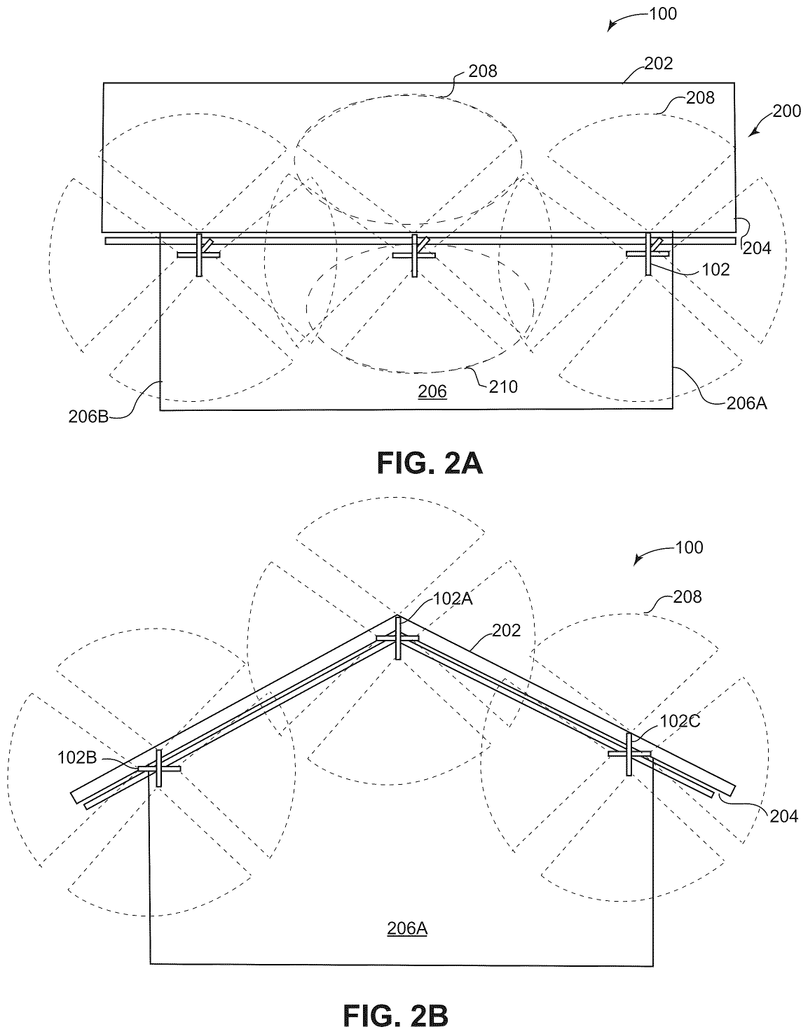

FIGS. 2A and 2B show water spray patterns of multidirectional sprinklers 102 in relation to a structure 200. In FIG. 2A, a sideview of structure 200 is shown, having a roof 202 and eaves 204 extending over walls 206. Multidirectional sprinklers 102 comprise four sprinkler heads in a cross pattern, whereby the sprinkler heads are directed 90 degrees apart. Sprinkler heads may produce 90-degree spray cones 208 that are directed both vertically and horizontally. Spray cones 208 from an individual multidirectional sprinkler 102 may cover a complete circle about the multidirectional sprinkler 102, having a radius of approximately 10 feet or greater. In at least one embodiment, multidirectional sprinklers 102 may be located 15 to 20 feet apart, enabling adjacent spray cones 208 to overlap and wet portions of roof 202 and walls 206.

Sprinkler heads of multidirectional sprinklers 102 produce fine water droplets both laterally and vertically that may easily be carried by air currents. Air currents (e.g., breezes and wind) may also carry embers from a nearby fire, blowing them in particular directions. Such embers may contact roof 202 and/or walls 206, for example. In addition, flammable objects, including vegetation within 10 feet of walls 206, may also be contacted by wind-driven embers and ignite such object. The sprayed water also may be blown in the same directions as embers, wetting surfaces and objects to mitigate the potential to ignite. As will be described below, fire protection system 100 may be activated in advance of embers landing on structure 200 and surrounding areas to wet the potentially flammable surfaces and significantly reduce or eliminate risk of ignition.

Vertically directed spray cones 208 may enable wetting of surface portions 208 and 210 of roof 202 and walls 206, respectively, whereas horizontally-directed spray cones 208 may also enable wetting of the same areas, where both vertically and horizontally directed spray cones 208 overlap and may reinforce each other's effect. The surfaces may receive sufficient water to thoroughly dampen them. Damp surfaces may not reach ignition temperatures within the time a fire is moving through the area of structure 200. For example, if a wildfire moves at approximately 30 to 40 miles per hour, the time the hottest part of the fire remains in the immediate vicinity of structure 200 may be short enough to allow the wetted surfaces to remain wet and thus resist ignition.

In FIG. 2B, a front or rear view of structure 200 is shown. Here, combined vertically and horizontally-directed spray cones 208 from the multidirectional sprinklers 102A-C may cover a large portion of wall 206A. Sprinkler heads may also produce longer range spray cones, thus enabling greater coverage. Downwardly sprayed water may also soak the ground in the immediate vicinity of wall 206A. Advantageously, fire protection system 100 enables wetting of the ground around structure 200 by providing vertically directed spray. Wetting of the immediate surroundings enables creation of defensible space that may extend out 10 feet from walls 206. As noted above, sprayed water droplets will also be carried by wind to places to which embers are also carried, reducing chances of ignition of those areas by the wind-blown embers.

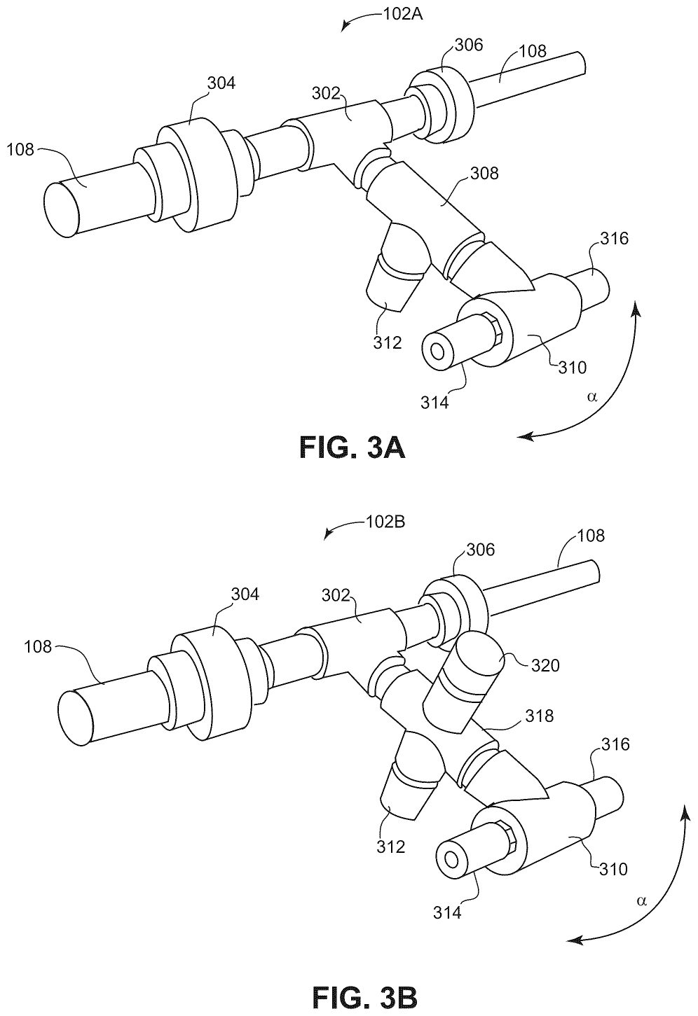

FIGS. 3A and 3B show multidirectional sprinklers 102A and 102B, respectively. In FIG. 3A, a three-way cross configuration is shown for multidirectional sprinkler 102A. Here, a tee adapter 302 is attached to conduit 108 through unions 304 and 306. Tee adapter 302 may be regarded as a hanger to suspend tee adapters 308 and 310, which couple to three orthogonally directed sprinkler heads 312-316. In at least one embodiment, sprinkler heads 312-316 may be identical, however in other embodiments, at least one of sprinkler heads 312-316 may be different from the others. For example, sprinkler head 312 may produce a different spray pattern or have a different range compared to sprinkler heads 314 and 316. Sprinkler heads 314 and 316 are horizontally directed and direct spray in opposition, for example, having a 180 degree separation.

In at least one embodiment, unions 304 and 306 are configured to be loosened to allow adjustment of the tilt angle α of multidirectional sprinkler 102A. Adjustment of tilt angle α enables aiming of vertically directed spray cones (e.g., spray cones 208, FIGS. 2A and 2B) to achieve desired (e.g. optimal) coverage of roof surfaces and surfaces under eaves. For example, metal roofs or class A roofs may need little to no wetting, so the spray may be directed away from the roof by tilting angle α to a more vertical angle, aiming downwardly directed sprinkler heads (e.g., sprinkler head 312) toward lower portions of the wall under the eave and to direct the upwardly directed sprinkler head (e.g., see FIG. 3B for sprinkler head 320) to spray water over an area of the ground adjacent to the wall under the eave. Horizontally directed sprinkler heads 314 and 316 are less affected by a change in the tilt angle α, except to change their height and therefore the coverage area.

FIG. 3B illustrates a four-way multidirectional sprinkler 102B. Here, three-way tee adapter 308 is replaced by a four-way cross adapter 318. Multidirectional sprinkler 102B adds the upwardly directed spray via inclusion of upwardly directed sprinkler head 320. Sprinkler head 320 is substantially opposed to sprinkler head 312.

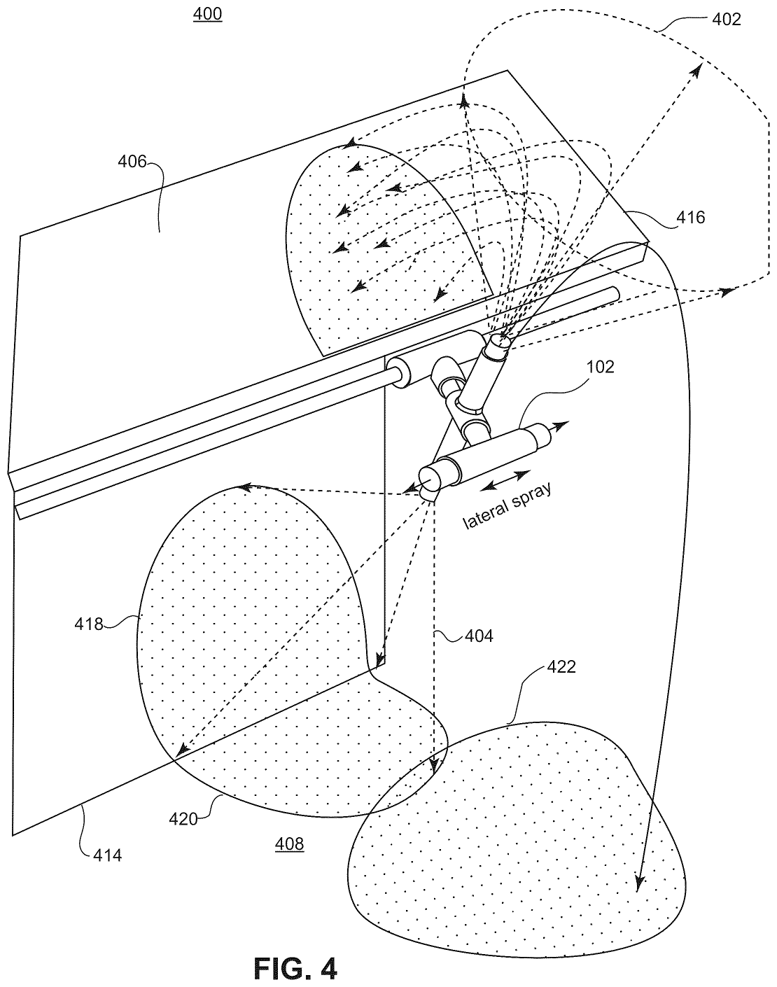

FIG. 4 shows an example of a wetting pattern 400 from a four-way multidirectional sprinkler 102. Here, multidirectional sprinkler 102 is tilted such that vertically directed spray cone 402 is aimed upwardly, partially over roof 406 and partially over ground 408 immediately below. Water spray droplets, indicated by the dotted arrows, falling downward land on wetted area 410 of roof 406 and wetted area 412 of ground 408. Spray cone 404 is directed at wall 414 under eave 416, such that area 418 of wall 414 and wetted areas 420 and 422 of ground 408 are wetted. Wetted areas 420 and 422 may overlap, creating an extended wet zone on ground 408. A wet zone extending 10 feet or more from wall 414 may be desirable.

Lateral spray is not shown for clarity. However, coverage by lateral spray may increase coverage by vertically directed spray.

FIG. 5 shows an example of a lateral wetting pattern 500 from a four-way multidirectional sprinkler 102. Spray emanating from lateral sprinkler heads 314 and 316 are indicated by the dotted arrows falling on wetted areas 502 and 504 on wall 414 and on wetted areas 506 and 508 of ground 408. Spray may also reach areas on roof 406, as indicated by wetted areas 510 and 512. Between individual multidirectional sprinklers located along eaves 416, wetted areas may overlap to completely cover roof 406, extending toward the gable.

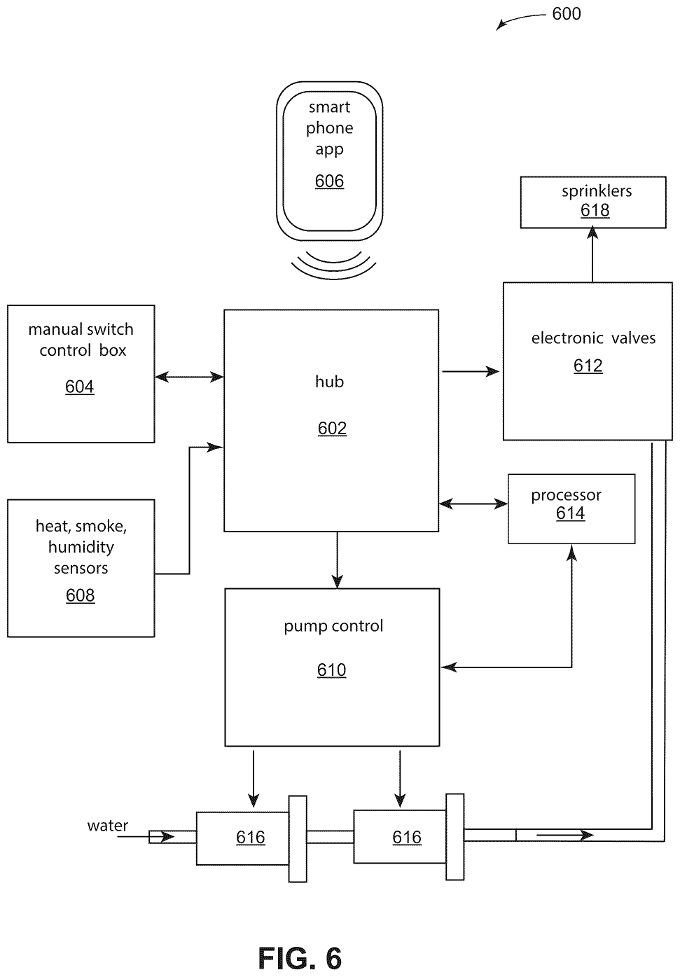

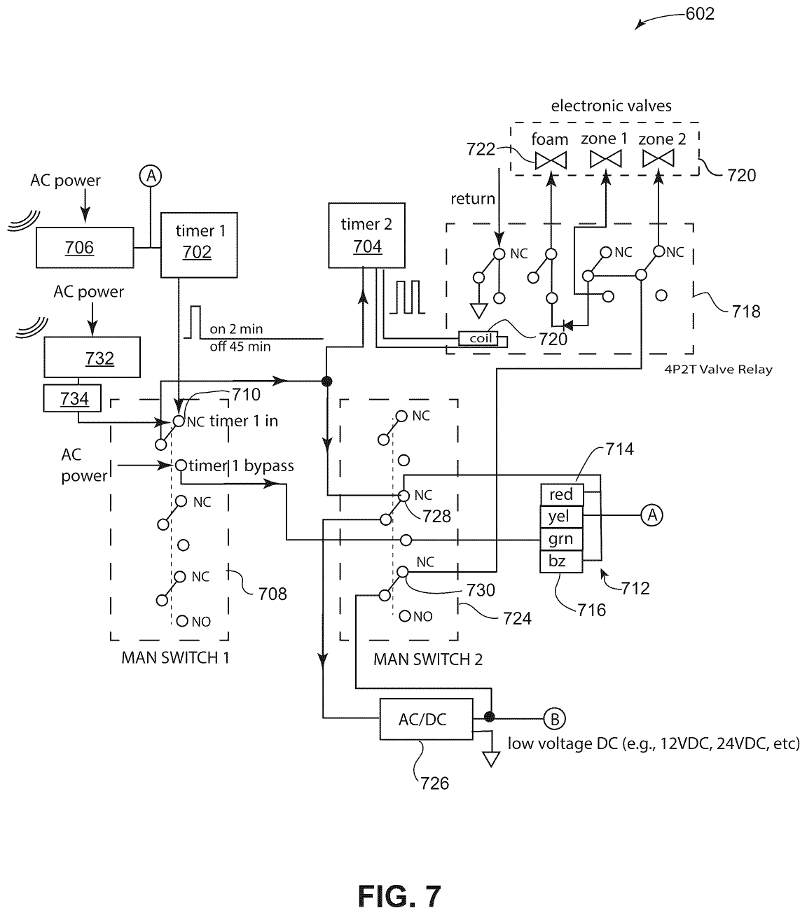

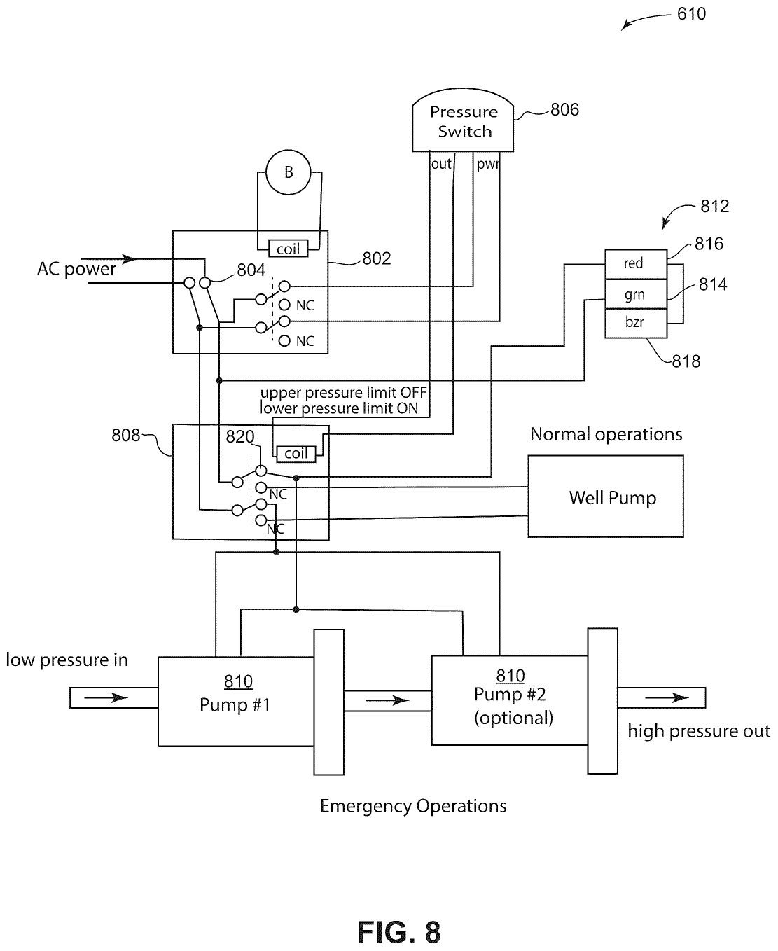

FIG. 6 shows a diagram of a control system 600 for manual and automatic control of fire protection system 100. Control system 600 comprises a central hub subsystem 602 that is interconnected to peripheral subsystems such as manual switch box subsystem 604 (e.g., control box 134 in FIG. 1), smart phone 606, external sensor subsystem 608, pump control module 610, and electronic valve subsystem 612. Central hub subsystem 602 and pump control module 610 are described in detail in FIGS. 7 and 8, respectively. Smartphone 606 may communicate wirelessly with central hub subsystem 602 via a specialized app. For example, smartphone 606 may communicate through a Bluetooth and/or WiFi connection with receivers in central hub subsystem 602. Smartphone 606 may also have an internet connection with central hub subsystem 602 for remote operation via the internet. Electronic valve subsystem is coupled to pumps 616 and sprinklers 618 via conduits and other plumbing described above.

In at least one embodiment, external sensor subsystem 608 may comprise one or more heat sensors, one or more humidity sensors, one or more smoke sensors, and other sensors that aid in detecting presence of fire or threat of nearby fire. Sensors may be deployed around a home or other structure to detect fire threats automatically. Sensors may also include cameras sensitive to infrared for heat detection.

In at least one embodiment, a processor 614 may be included in system 600 to execute automated control functions via software. Processor 614 may communicate with central hub subsystem 602 and pump control subsystem 610. Processor 614 may comprise a stand-alone microprocessor, for example, such as an Arduino board, Raspberry Pi or equivalent.

FIG. 7 shows a diagram of central hub subsystem 602. In at least one embodiment, central hub subsystem 602 comprises timer 702 and timer 704. Timer 702 is coupled to timer 704, but can be bypassed, as described below. Timers 702 and 704 may be mechanical timers or electronic timers. Timer 702 is coupled to an activation interface 706 that may be wirelessly activated. In at least one embodiment, activation interface 706 may be called by a smartphone app via local wifi or internet to start timer 702. In some embodiments, activation unit 706 is hard-wired to a switch or trigger source. Activation interface 706 may be powered by a local AC source (AC power), such as a wall outlet, power inverter or generator. In some embodiments, AC power may be nominally 110 VAC. In other embodiments, AC power may be nominally 220 VAC. Timer 702 may be configured to pass AC power when activated. In at least one embodiment, activation unit 706 may comprise a program to control the timing function of timer 702. Additionally, timer 702 may have an internal processor that generates a timing duty cycle. As an example, timer 702 may be operated to close an internal switch for a first period or on time of the duty cycle and then open the switch for a second period or off time of the duty cycle. For example, the first period may be two minutes on, and the second period may be 45 minutes off. In this manner, water may be conserved, for example, from a tank, or a municipal supply may not be drained to dangerously low levels.

Under normal operation, switch 708 is a three pole, double throw switch that is set in an “off” position where contacts are normally closed (NC). Timer 702 is coupled to a pole 710 of switch 708. When timer 702 is on, the AC power is routed to timer 704 through the circuit made by the switch contact. A duty cycle of timer 704 may then be set to produce a different timing sequence, for example one minute on and one minute off. At the same time, power is also routed to group of warning light indicators, such as light tower 712, comprising a stack of red, yellow, and green lights. Specifically, power is routed to light tower 712 to activate red light 714 and optionally a buzzer 716 to indicate the status of fire protection system 100

During the on time of timer 704, power is routed to the electromagnet 718 of relay 720. Relay 720 may be a four-pole double throw relay, for example. Relay 720 may be a mechanical relay or an electronic (e.g., solid state) relay. Thus, relay 720 is switched during each phase of the duty cycle of timer 704. Output contacts of relay 720 are coupled electronic valves 722. The electronic valves 722 may control zones of sprinklers. Here, electronic valves in different zones may be switched in and out to disperse water sequentially. In at least one embodiment, water may be mixed with a fire retardant foam via an eductor nozzle (not shown), and electronic valve 724 for mixing control is open at all times during the on time of timer 704.

In at least one embodiment, a second switch 724 is also included in central hub subsystem 602. Switch 724 may also be a manually operated switch. In the normally closed position, power is routed passively through switch contacts as shown. In at least one embodiment, AC power is routed to power converter 726 via contact 728 of switch 724. Power converter 726 converts AC power (e.g., 110 VAC) to a low-voltage DC power. For example, power converter may output 12 VDC, 24 VDC, 48 VDC, etc., to operate electronic valves 720. DC power is routed to relay 718 via NC pole 730 of switch 724. Junction B in the diagram of FIG. 7 routes lower voltage DC power to pump control subsystem 610, shown in FIG. 8.

Switch 724 provides an option to enable manual operation of fire protection system 100 by allowing manual switching to the normally open (NO) position. In the event that the system is to be manually operated, switch 724 may be switched to the NO position, where pole 730 is disengaged and power is cut off from relay 718 and thus electronic valves 720 are no longer operational. An example scenario of this case is when a fire truck is available to supply water directly to sprinklers through an FDC inlet to the system, for example FDC inlet 132 in FIG. 1. Here, electronic valves are not needed and may be bypassed by manual switching of switch 724.

Switch 724 may also disconnect shore power to power converter 726, thus stopping generation of DC power.

In at least one embodiment, central hub subsystem 602 provides for an extreme emergency, for example if fire is very close to a structure, to bypass timer 702 and operate timer 704 directly. This may be accomplished by activating activation interface 732. Activation interface 732 may be wirelessly contacted by a smartphone app, disabling activation interface 706. When activated, activation interface 732 provides shore power to timer 734. Here, shore (AC) power is routed to timer 704 to execute its short duty cycle (e.g., one minute on, one minute off). Timer 734 may provide a longer duty cycle to control timer 704, for example by turning on timer 704 for a first period, and turning off timer 704 for a second period. Optionally switch 708 may be switched to the NO position. As an example, timer 734 may be on for 20 minutes and off for 20 minutes. During the on time of timer 734, timer 704 is active to operate on its short duty cycle (e.g., one minute on/one minute off). In this example, timer 704 may execute 10 on/off cycles. Timer 704 operates relay 718, thus electronic valve zones may be switched alternately as noted above. After the first 20 minutes, timer 734 is in the off state, timer 704 is not active, and electronic valves 720 are thus not activated. In this manner, water may be conserved as noted above. It may be understood that duty cycles of timers 702, 704 and 734 may all be adjusted to any suitable ranges for adapting fire protection system 100 to particular situations.

FIG. 8 shows a diagram of pump control subsystem 610. When DC power is provided from junction B in FIG. 7, relay 802 is activated. When activated, relay 802 switches from the NC position to connect AC power at terminals 804 to pressure switch 806. In at least one embodiment, pressure switch 806 may be programmed to operate in such a manner that at limits of a water pressure range, it opens and closes. For example, pressure switch 806 outputs AC power to relay 808 when pressure of water within the sprinkler supply (e.g., pressure within riser 122 (FIG. 1) remains below a maximum value. The AC power activates relay 808, switching from the NC position to disengage other AC circuits, for example, operating a well pump under normal conditions, and switch in emergency pumps 810.

Status indicator lights on light tower 812 may also be operated by relays 802 and 808. Under normal (non-emergency) conditions, green light 814 is connected to AC power at all times to indicate the system is powered. When relay 802 is switched in emergency conditions, red light 816 and buzzer 818 are connected to AC power via contact 820 of relay 808.

What is claimed is:

1. A fire protection system, comprising:
a pumping system comprising at least one water pump;
at least one hose coupled to the pumping system;
a control valve coupled to the pumping system; and
a plurality of multidirectional sprinklers coupled to the control valve; and
a control system coupled to the pumping system and to the control valve, wherein the control system comprises a first timer and a second timer, wherein the first timer is configured to be activated by a wireless interface, and wherein the second timer is coupled to the first timer and is controlled by the first timer, and wherein the second timer operates the control valve.

2. The fire protection system of claim 1, wherein the control system comprises a pressure switch that is operational to shut off the pumping system when a water pressure within the plurality of multidirectional sprinklers exceeds an upper pressure limit of a range of pressures, and to operate the pumping system when the water pressure is below the upper pressure limit

3. The fire protection system of claim 1, wherein individual multidirectional sprinklers of the plurality of multidirectional sprinklers comprise at lease three sprinkler heads, wherein the three sprinkler heads are orthogonally disposed relative to one another.

4. The fire protection system of claim 1, wherein individual multidirectional sprinklers of the plurality of multidirectional sprinklers comprise four sprinkler heads disposed orthogonally with respect to one another.

5. The fire protection system of claim 1, wherein individual multidirectional sprinklers of the plurality of multidirectional sprinklers are configured to be pivotable when mounted on a conduit, wherein the individual multidirectional sprinklers can rotate about an axis coaxial with the conduit.

6. The fire protection system of claim 1, wherein the plurality of multidirectional sprinklers are coupled together by one or more conduits, and wherein the conduits are to be coupled together as a continuous loop.

7. The fire protection system of claim 6, wherein the plurality of multidirectional sprinklers are to be attached at substantially regular intervals around the continuous loop of conduit.

8. The fire protection system of claim 6, wherein the one or more conduits comprise an expansion segment, wherein the expansion segment comprises a U shaped configuration of conduits having a length of 30 inches or less.

9. The fire protection system of claim 6, wherein the one or more conduits have an inner diameter that is at least one inch.

10. The fire protection system of claim 6, wherein the one or more conduits are coupled to the pumping system through a riser, wherein the control valve is in line with the riser, wherein the riser comprises a bypass loop that bypasses the control valve, and wherein the bypass loop comprises a manual valve.

11. The fire protection system of claim 6, wherein a fire department connection (FDC) inlet is coupled to the plurality of multidirectional sprinklers.

12. A system, comprising:
A fire protection system mounted on a structure, wherein the fire protection system comprises:
a pumping system comprising at least one water pump;
at least one hose coupled to the pumping system;
a control valve coupled to the pumping system; and
a plurality of multidirectional sprinklers coupled to the control valve; and
a control system coupled to the pumping system and to the control valve, wherein the control system comprises a first timer and a second timer, wherein the first timer is configured to be activated by a wireless interface, and wherein the second timer is coupled to the first timer and is controlled by the first timer, and wherein the second timer operates the control valve;
a system of sensors coupled to the control system;
an electrical source coupled to the control system; and
a water source coupled to the pumping system.

13. The system of claim 12, wherein the system of sensors comprises a heat sensor, a smoke sensor and a humidity sensor.

14. The system of claim 12, wherein the plurality of multidirectional sprinklers is mounted on an edge of a roof of the structure.

15. The system of claim 12, wherein the control system is coupled to at least one light tower, wherein the at least one light tower comprises multiple colored lights that are configured to be activated by one or more relays within the control system.

16. The system of claim 12, wherein the control system comprises a first manual switch, wherein the first manual switch is configured to bypass the first timer and activate the second timer, and wherein the control system comprises a second manual switch, wherein the second manual switch is configured to disable the system of sensors and shut off power to the control valve and the pumping system.

17. The system of claim 12, wherein the control system includes a first activation interface and a second activation interface, wherein the first activation interface is coupled to the first timer, and the second activation interface is coupled to the second timer, and wherein the first activation interface is configured to provide a first timing sequence to the first timer, and wherein the second activation interface is configured to provide a second timing sequence to the second timer and to deactivate the first timer.

18. The system of claim 17, wherein the first activation interface and the second activation interface are configured to be operated wirelessly by a smartphone application, wherein the smartphone application communicates with the first activation interface and the second activation interface over local wifi, Bluetooth or the internet.

19. The system of claim 12, wherein the pumping system comprises a single pump or multiple pumps connected in series.

20. The system of claim 19, wherein the pumping system is configured to deliver water at 90 gallon per minute or greater, at a pressure of at least 90 psi.
